(19) United States
(12) Patent Application Publication
(10) Pub. No.: US 2007/0200962 A1
(43) Pub. Date: Aug. 30, 2007

(54) Rotation apparatus of display

(75) Inventors: Dong-Won Choi, Suwon-si (KR); Chil-Sung Lee, Suwon-si (KR); Yang-Ho Moon, Ansan-si (KR); Jae-Kyung Kim, Ansan-si (KR); Kyoung-Shin Park, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/701,533

(22) Filed: Feb. 2, 2007

(30) Foreign Application Priority Data
Feb. 3, 2006 (KR) 10-2006-0010459

(51) Int. Cl. H04N 5/64

(52) U.S. Cl. 348/794

(57) ABSTRACT

The present invention is to provide a rotation apparatus of a display preventing the damage of the deceleration gear and the rotor of the motor. In one aspect, the invention features a rotation apparatus of a display, which comprises a stand, a guide joined to the stand rotatably and configured to support the display, a motor fixed to the stand and configured to have a shaft, a rotation transfer member joined to the shaft and configured to have transfer the rotational force of the motor selectively, wherein the rotation transfer member makes the rotational force of the motor is transferred to the guide at the time of automatic rotation.

### CROSS-REFERENCE TO RELATED APPLICATIONS

This application claims the benefit of Korean Patent Application No. 10-2006-0010459 filed with the Korean Intellectual Property Office on Feb. 3, 2006, the disclosure of which is incorporated herein by reference in its entirety.

### BACKGROUND

1. Technical Field

The present invention relates to a rotation apparatus of a display.

2. Description of the Related Art

As the size and weight of a display such as a computer monitor or a television set are increased, a rotation apparatus capable of rotating the display is widely being used. The rotation apparatus uses a motor to point the display toward a user.

FIG. 1 is a schematic diagram of a conventional rotation apparatus of a display. Referring to FIG. 1, a conventional rotation apparatus of a display includes a stand 11 fixed to the floor and a motor 13 having one end fixed to the stand 11 and the other end joined to a display 15. While it is not illustrated, the motor 13 is joined to an external control apparatus to allow the user to control the position of the display using a remote controller, etc. Also, the motor 13 has deceleration gears in its interior, because it is necessary to rotate heavy-weight displays 15 slowly.

Although the rotation apparatus of a display uses an external power supply to drive the motor 13, it is necessary that the user rotate the display manually when there is no power supply to the rotation apparatus. However, if the display 15 is rotated manually, the shaft 17 connecting the display 15 and the motor 13 is rotated as well, so that the deceleration gears and the rotor of the motor 13 are damaged.

### SUMMARY

An aspect of the present invention is to provide a rotation apparatus of a display that can prevent the damaging of the deceleration gear and the rotor of the motor.

In one aspect, the invention features a rotation apparatus of a display, which comprises a stand, a guide joined to the stand rotatably and configured to support the display, a motor fixed to the stand and having a shaft, a rotation transfer member joined to the shaft and configured to selectively transfer the rotational force of the motor, where the rotation transfer member transfers the rotational force of the motor to the guide at times of automatic rotation.

Embodiments may include one or more of the following features. For example, the rotation transfer member may have a solenoid switch joined to the shaft and a clutch of which both ends are joined to the solenoid switch and the guide respectively, where the solenoid switch may transfer the rotational force of the motor to the guide through the clutch at times of automatic rotation.

The rotation transfer member may include a vertical cam joined to the shaft and a clutch having both ends joined to the vertical and the guide respectively, where the vertical cam may move the clutch such that the rotational force of the motor is transferred to the guide through the clutch at times of automatic rotation The rotation transfer member may comprise an electrical clutch joined to the guide and the shaft respectively, where the electrical clutch may transfer the rotational force of the motor to the guide at times of automatic rotation.

The stand may have an insertion hole in which the motor is fixed and rotation holes arranged around the insertion hole and configured to have a predetermined rotation angle, a fixing member is inserted into the rotation hole and configured to have predetermined rotation angles, where a fixing member may be inserted into the rotation hole and fixed to the guide. Also, a bearing may be interposed between the guide and the stand and/or between the guide and the fixing member. The rotation hole may have a latch groove around its outer surface, and the electric clutch may include a cylinder, which is joined to the guide and in which the shaft is inserted, and a latch member located in the cylinder and configured to latch onto the latch groove to press the inner surface at times of automatic rotation.

Also, the latch member may have a shaft latch part that latches onto the latch groove and a cylinder latch part formed as a single body with the shaft latch part, where the cylinder latch part may have a cutting part configured to press the inner surface of the cylinder at times of automatic rotation. A power spring cam may be joined to the shaft to provide a rotational force of an opposite rotary direction to that of the shaft.

### BRIEF DESCRIPTION OF THE DRAWINGS

FIG. 1 is a schematic diagram of a conventional rotation apparatus of a display.

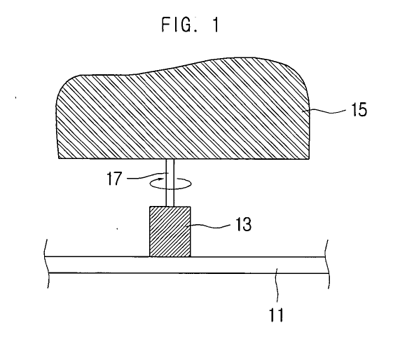

FIG. 2 is a cross sectional view of a rotation apparatus of a display in accordance with the first embodiment of the invention using a solenoid switch.

FIG. 3a is a schematic diagram of a separated clutch.

FIG. 3b is a schematic diagram of an engaged clutch when a solenoid switch is operated.

FIG. 4 is a plan view of a fixing member inserted into a stand.

FIG. 5 is a cross sectional view of a rotation apparatus of a display in accordance of the other aspect of the present invention.

FIG. 6a is a schematic view of a separated clutch.

FIG. 6b is a schematic view of an engaged clutch when a vertical cam is operated.

FIG. 7 is a cross sectional view of a rotation apparatus of a display using an electric clutch in accordance of the other aspect of the present invention.

FIG. 8a is a schematic diagram illustrating a latch member isn't latched at a latch groove.

FIG. 8b is a schematic diagram illustrating a latch member is latched at the latch groove of the shaft to press inner surface of a cylinder.

### DETAILED DESCRIPTION

Hereinafter, an embodiment of a rotation apparatus of a display according to the present invention will be described in more detail with reference to the accompanying drawings.

Embodiments of the rotation apparatus of a display according to the invention will be described below in more detail with reference to the accompanying drawings. In the description with reference to the accompanying drawings, those components are rendered the same reference number that are the same or are in correspondence regardless of the figure number, and redundant explanations are omitted. Also, the basic principles will first be described before discussing the preferred embodiments of the invention.

Before the rotation apparatus in accordance with one embodiment of the present invention is explained, the meaning of automatic rotation and manual rotation will be defined. Automatic rotation is meant to rotate a display using a driving force of a motor and manual rotation is meant to the user rotate a display or a guide configure to support the display manually. Standby situation is defined no rotation of a display by a user or a motor and ready to rotated by a user or a motor.

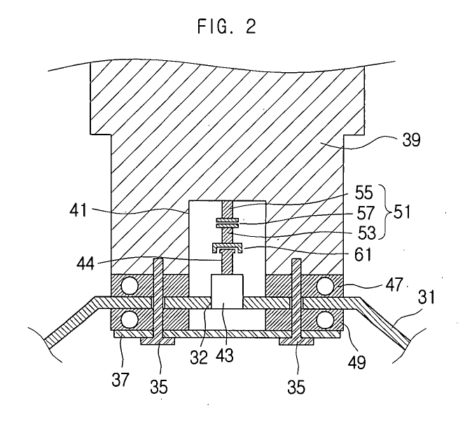

Referring to FIG. 2, the rotation apparatus of a display in accordance with one embodiment of the present invention has a stand 31, a guide 39 joined to the stand rotatably and configured to support the display (unseen), a motor 43 fixed to the stand 31 and configured to have a shaft 44, a solenoid switch 61 joined to the shaft 44 and a clutch 51 of which both ends are joined to the solenoid switch 61 and the guide 39 respectively. And an upper bearing 47 is interposed between the guide 39 and the stand 31, a lower bearing is interposed between the stand 31 and a bracket 37. A fixing member 35 combines the bracket 37 and the guide.

The rotation apparatus of a display in accordance with one embodiment of the present invention can prevent the damage of a deceleration gear because at the time of manual rotation the clutch 51 is separated, so that the passive shaft 55 of the clutch 51 is rotated but the shaft 44 of the motor 43 and the deceleration aren't rotated. And at the time of automatic rotation, solenoid switch 61 moves the clutch 51 to be engaged each other, so that the rotational force of the motor 43 is transferred to the guide 39 through the clutch 51 by the operation of a solenoid switch 61.

The guide 39 is rotated with the driving shaft 53 and the passive shaft 55 of the clutch 51 and the bracket 37 and the fixing member 35 at the time of automatic rotation. And at the time of manual rotation, the guide 39 is rotated with the passive shaft 55, the bracket 37 and the fixing member. A display such a television or a monitor is mounted or located on the guide 39, the direction of the display is determined by the rotation of the guide 39. The guide 39 is joined with the stand 31 by the medium of the upper bearing 47, and configured to maintain the display at a predetermined altitude when the driving shaft 53 and the passive shaft 55 are engaged each other as well as the driving shaft 53 and the passive shaft 55 separated each other.

At the center of the guide 39 a rotation hole 41 at which the clutch 51 and the solenoid switch 61 are located is formed. The passive shaft 55 of the clutch 51 is fixed to the upper surface of the rotation hole 41. And the rotation hole 41 is in communication with the insertion hole 32 of the stand 31.

The shape of the guide 39 can have, for example, circular or rectangular plate and can have any shape if the display can be located or mounted. And the guide is formed as a single body in accordance with the design condition.

The stand 31 is fixed to a floor or a wall to support the rotation apparatus of a display. An insertion hole 32 to which the motor 43 is fixedly inserted is formed at the center of the stand 31. The insertion hole 32 is in communication with the rotation groove 41 of the guide 39. The insertion hole 32 and the rotation groove 41 are the center of the rotation.

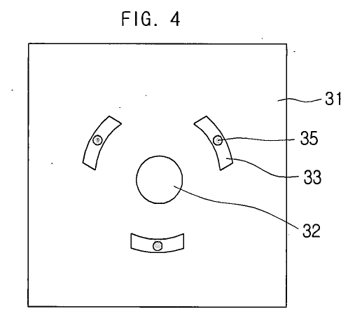

As illustrated in the FIG. 4, plural rotation holes 33 are formed around the circumference of the insertion hole 32. The insertion hole 33 to which the fixing member 35 is inserted has the same central angle. Consequently, the fixing member 35 rotated as a single body with the guide 39 is guided by the rotation hole 33. And the angle the guide 39 and the fixing member 35 can rotate is determined by the central angle of the rotation hole 33.

The motor 43 has the shaft 44 inserted and fixed to the rotation groove 41 of the guide 39 and joined with the solenoid switch 61. The rotor of the motor 43 is comprised of shaft 44, coils and magnets. And the motor 43 has a deceleration gear to decrease the rotational speed of the display and increase the torque. The deceleration gear composed of gear trains diminishes the rotational force generated by the motor 43 and gets a greater torque.

The motor 43 can be DC motor or AC motor, which can provide the swivel hinge 45 the rotational force.

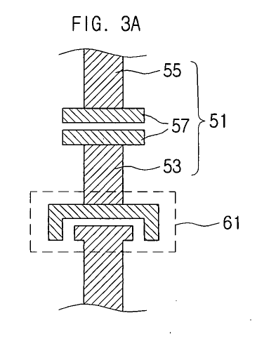

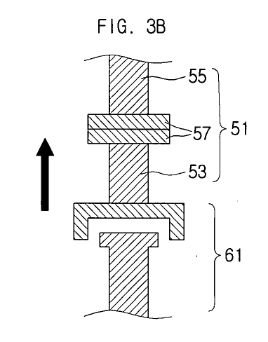

As illustrated in FIG. 3b, if a current is supplied, the solenoid switch 61 elevates electromagnetically the drive shaft 53 of the clutch 51 vertically to engage with the passive shaft 55. And the solenoid switch 61 is operated at the time of the automatic rotation transfer the rotational force of the motor 43 to the guide 39 through the drive shaft 53 and the passive shaft 55 of the clutch 51. If a current isn't supplied to the solenoid switch 61, as illustrated in FIG. 3a, the passive shaft 55 and the drive shaft 53 are separated each other. Because at the time of the manual rotation the solenoid switch 61 isn't operated, the passive shaft 55 and the guide 39 are rotated but the drive shaft 53 and shaft 44 of the motor 43 aren't rotated. Consequently, the rotation apparatus of a display can prevent the damage of the deceleration gear and the rotor of the motor.

The clutch 51 comprises the passive shaft 53 joined with the solenoid switch 61, the passive shaft 55 joined with the guide 39 and a pair of disk 57 formed at one end of the drive shaft 53 and the passive shaft 55.

The drive shaft 53 is joined with the solenoid switch 61 and configured to be elevated by the operation of the solenoid switch 61 to make the disks of the drive shaft 53 and the passive shaft 55 are engaged each other. Consequently, the driving force of the motor 43 is transferred to the guide 39 at the time of the automatic rotation.

The passive shaft 55 is joined with guide 39, and as illustrated in FIG. 3a, separated from the drive shaft 53 if a current isn't provided to the solenoid switch.

The disk 57 is formed at one end of the drive shaft 53 and the passive shaft 55 and faced each other. And both the disks 57 are engaged when the solenoid switch 61 is operated. Because the disks 57 are engaged each other by the operation of the solenoid switch 61, the drive shaft 53 can provide the rotational force of the motor 43.

The fixing member 35 is penetrated to the rotation hole 33 of the stand 31 and inserted fixedly to the lower end of the guide 39. The fixing member 35 rotates with the guide 39 and the bracket 37, and supports the guide 39 rotatably at the stand 31. As illustrated in FIG. 4, the fixing member 35 is inserted to the rotation hole 33. The rotation hole 33 restricts the rotational angle of the fixing member 35.

The bracket 37 is interposed between the fixing member 35 and lower bearing 49 and configured to support the fixing member 35. And upper bearing 47 is interposed between the stand 31 and the guide 39. The lower bearing 49 and the upper bearing 47 smoothes the rotation of the bracket 37 and the guide 39 respectively. The lower bearing 49 and the upper bearing 47 can be ball bearing or conventional bearing.

The automatic rotation and the manual rotation of the rotation apparatus of a display according to one embodiment of present invention will be explained referring to the FIG. 2, FIG. 3 and FIG. 4.

Referring to the FIG. 3a, the passive shaft 55 and the drive shaft 53 of the clutch 51 are separated each other at the standby situation. The display is supported by the guide 39 at the standby situation. If a user wants to rotate the display manually, the guide 39, the passive shaft 55 separated from the drive shaft 53 and joined to the guide 39, the fixing member 35 and the bracket 37 are rotated because the solenoid switch 61 isn't operated. Consequently, the shaft 44 of the motor 43 and the deceleration gear joined to the shaft 44 are not rotated at the time of the manual rotation; the damage of the shaft 44 and the deceleration gear can be prevented. The rotational angle of the guide 39 is determined by the central angle of the rotation hole 33 as illustrated in FIG. 4.

And if a user wants to rotate the display automatically, the motor 43 and the solenoid switch 61 are operated, so that the drive shaft 53 is elevated to engage with the passive shaft 55 as illustrated in FIG. 3b. If the motor 43 is operated, the driving force of the motor 43 is transferred to the guide 39 through the clutch 51, consequently the guide 39, the drive shaft 53 and passive shaft 55 of the clutch 51, the bracket 37 and the fixing member 35 are rotated. Because the solenoid switch 61 continues to operate during the operation of the motor 43, the drive shaft 53 and the passive shaft 55 are engaged by the disk 57. And the automatic rotation is ended, the motor 43 and the solenoid switch 61 cease to operate and the standby situation is started as illustrated in FIG. 3a.

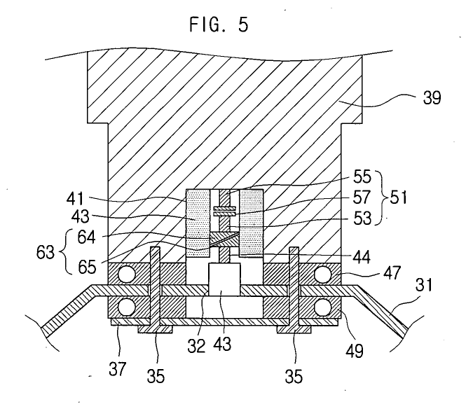

The other embodiment of rotation apparatus of display according to the present invention will be explained referring to the FIG. 5, 6a and 6b.

Referring to FIG. 5, the other embodiment of rotation apparatus of display has the same structure to that of the one embodiment of rotation apparatus illustrated from FIG. 2 to FIG. 4 except the vertical cam 63 is used instead of the solenoid switch 61. Consequently, the difference of the structure will be explained mainly.

The vertical cam 63 of the present embodiment is composed of upper cam 64 and the lower cam 65 formed by cutting a cylinder diagonally and coupled each other. The upper cam 64 is connected to the drive shaft 53 of the clutch 51 and the lower cam is connected to the shaft 44 of the motor 43. The lower cam 65 is rotated by the motor 43 to elevate toe upper cam 64 vertically, so that the clutch 51 is engaged each other. Because the vertical cam 63 is confined by the inner surface 66 of the guide 39, the upper cam 64 can move linearly restricted by the inner surface 66 owing to the rotation of the lower cam 65.

The operation of the rotation apparatus of display according to the present embodiment will be explained referring to the FIG. 5, 6a and 6b.

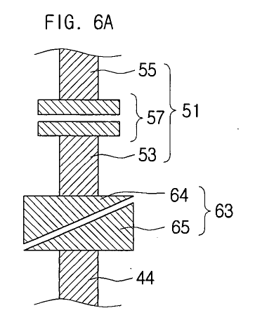

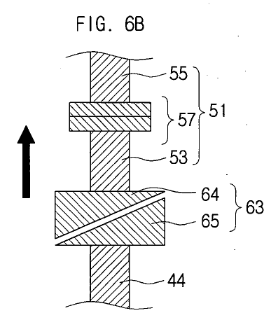

Referring to FIG. 6a, at the standby situation, the drive shaft 53 and the passive shaft 55 of clutch 5 are separated each other. If a user rotates the display or the guide 39 manually, the shaft 44 and deceleration gear of motor 43 aren't rotated to prevent the damage of the shaft 44 and deceleration gear. It is because the clutch 51 is separated at that time. At the time of the manual rotation, the guide 39, the passive shaft 55, the fixing member 35 and the bracket 37 are rotated. And the rotational angle of the display is determined by the rotation hole 33 formed at the stand 31.

At the time of the automatic rotation, the motor 43 is operated to rotate the lower cam 65 joined with the shaft 44, so that the upper cam 64 contacted to the lower cam 65 is guided by the inner surface 66 and configured to elevate vertically. Consequently, as illustrated in FIG. 6b, the drive shaft 53 and the passive shaft 55 of clutch 51 are engaged each other, and the rotational force of the motor 43 is transferred to the guide 39 through the clutch 51 to rotate the guide 39 and the display.

The rotation of the guide 39 and the display is ended; a rotational force opposite to the rotation direction of the shaft 44 is applied to the shaft 44 by the power spring combined to the shaft 44 of the motor 43, so that the lower cam 65 is separated from the upper cam 64 and drive shaft 53 and the passive shaft 55 also separated by some rotation of the shaft 44. And the rotation apparatus of a display according to the present embodiment is entered to the standby situation.

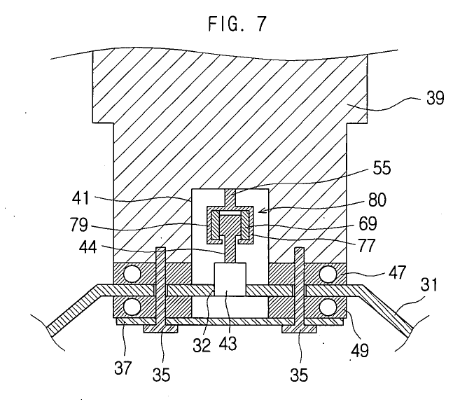

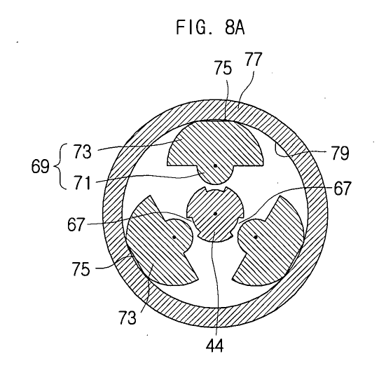

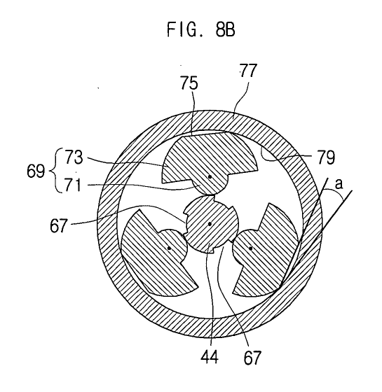

The other embodiment of a rotation apparatus of the present invention will be explained referring to the FIG. 7, FIG. 8a and FIG. 8b.

Referring to the FIG. 7, FIG. 8a and FIG. 8b, the rotation apparatus according to the present embodiment has the same structure explained referring FIG. 2, FIG. 3 and FIG. 4 except the shaft 44 of the motor 43 is connected to the guide 39 by the electric clutch 80 not having the clutch. So, below explanation is focused on the structural difference of the rotation apparatus of the present embodiment.

As illustrated in FIG. 8a and FIG. 8b, latch grooves 67 are formed around the outer surface of the shaft 44. Three latch grooves 67 are arranged having the same gap and have a predetermined depth. So, one end of the shaft latch part 71 of the latch member 69 can be latched at the latch grooves 67. And a power spring (unseen) is combined to the shaft 44 and configured to provide the rotational force opposite to the rotation direction of the shaft 44.

The electric clutch 80, as illustrated in FIG. 7, has a cylinder 77 formed as a single body with the passive 55. And the latch members 69 are arranged having the same gap inside of the cylinder 77. The latch member 69 presses the inner surface 79 of the cylinder 77 by the rotation of the shaft 44, part of it is inserted to the inside of the cylinder 77, so that the rotation of the shaft 44 is transferred to the guide 39 through the passive 55.

The latch member 69, as illustrated in FIG. 8a and FIG. 8b, is comprised of a shaft latch part 71 and cylinder latch part 73 joined each other and configured to have a different diameter.

The shaft latch part 71 is configured to have a smaller diameter than the cylinder latch part 73 and separated from the shaft 44 at the time of the standby situation and the manual rotation as illustrated in FIG. 8a. And at the time of the automatic rotation, the shaft latch part 71 is, as illustrated in FIG. 8b, latched at the latch groove 67 of the shaft 44, so that the cylinder latch part 73 is configured to press the inner surface 79 of the cylinder 77.

The cylinder latch part 73 has a greater diameter than the shaft latch part 71 and a cutting part 75 formed flatly at one side of it. The cylinder latch part 73 is formed as a single body with the shaft latch part 73. And one end of the cutting part 75 is configured to press the inner surface of the cylinder by the shaft latch part 71 latched at the latch groove 67 because of the rotation of the shaft 44. Consequently, the cylinder 77 is configured to receive the rotational force of the shaft 44 and transfer it to the passive shaft 55, which is formed as a single body with the cylinder 77 and the guide 39.

The cylinder 77 is shaped cylindrically opened at the center of it and the upper surface of it is joined to the passive shaft 55, which is connected to the guide 39. The cylinder 77 has an inner surface 79 confining the inside space, it is contacted to the one end of the cutting part 75 as illustrated in FIG. 8b.

The operation of the rotation apparatus of a display according to the present invention will be explained referring to the FIG. 7, FIG. 8a and FIG. 8b.

At the standby situation, as illustrated in FIG. 8a, the shaft latch part 71 is separated not latched at the latch groove 67. And both ends of the cutting part 75 is only contacted to the inner surface 79 of the cylinder 77 but not configured to press. Consequently, if the display is rotated manually, the guide 39, the passive shaft 55 and the cylinder 77 joined to the passive shaft 55, the fixing member 35 and the bracket 31 are rotated. And at the time of the manual rotation, the shaft 44 of the motor 43 and the deceleration gear connected to the shaft 44 aren't rotated, so that the damage of the shaft 44 and the deceleration gear can be prevented.

And at the time of the automatic rotation, the shaft latch part 71 of the latch member 69 is latched at the latch groove 67, so that one end of the cutting part 75 of the cylinder latch part 73 is configured to press the inner surface 79 of the cylinder 77. At this time, angle of inclination (a) is formed between the cutting part 75 and the inner surface 79. Accordingly, the latch member 69 is latched at the shaft 44 and cylinder 77 at the time of the automatic rotation; the rotational force of the shaft 44 is transferred to the cylinder 77 combined with the passive shaft 55.

After the automatic rotation is ended, the elastic restoring force opposite to the rotation direction of the shaft 44 is acted to the shaft 44 by the power spring; so the rotation apparatus of a display according to the present embodiment is returned to the standby situation as illustrated in FIG. 8a.

While the present invention has been described with reference to particular embodiments, it is to be appreciated that various changes and modifications may be made by those skilled in the art without departing from the spirit and scope of the present invention, as defined by the appended claims and their equivalents.

What is claimed is:

1. A rotation apparatus of a display, the rotation apparatus comprising:
a stand;
a guide joined to the stand rotatably and configured to support the display;
a motor fixed to the stand and having a shaft; and
a rotation transfer member joined to the shaft and configured to selectively transfer the rotational force of the motor,
wherein the rotation transfer member is configured to transfer the rotational force of the motor to the guide at times of automatic rotation.

2. The rotation apparatus of claim 1, wherein the rotation transfer member comprises a solenoid switch joined to the shaft and a clutch having both ends thereof joined to the solenoid switch and the guide respectively, and
the solenoid switch is configured to move the clutch such that the rotational force of the motor is transferred to the guide through the clutch at times of automatic rotation.

3. The rotation apparatus of claim 1, wherein the rotation transfer member comprises a vertical cam joined to the shaft and a clutch having both ends thereof joined to the vertical and the guide respectively, and
the vertical cam is configured to move the clutch such that the rotational force of the motor is transferred to the guide through the clutch at times of automatic rotation.

4. The rotational apparatus of claim 1, wherein the rotation transfer member comprises an electrical clutch joined to the guide and the shaft respectively, and
the electrical clutch is configured to transfer the rotational force of the motor to the guide at times of automatic rotation.

5. The rotational apparatus of claim 2, wherein the stand has an insertion hole having the motor fixed therein and rotation holes arranged around the insertion hole and configured to have predetermined rotation angles, and
a fixing member is inserted into the rotation hole and fixed to the guide.

6. The rotational apparatus of claim 3, wherein the stand has an insertion hole having the motor fixed therein and rotation holes arranged around the insertion hole and configured to have predetermined rotation angles, and
a fixing member is inserted into the rotation hole and fixed to the guide.

7. The rotational apparatus of claim 4, wherein the stand has an insertion hole having the motor fixed therein and rotation holes arranged around the insertion hole and configured to have predetermined rotation angles, and
a fixing member is inserted into the rotation hole and fixed to the guide.

8. The rotational apparatus of claim 2, wherein a bearing is interposed between the guide and the stand.

9. The rotational apparatus of claim 3, wherein a bearing is interposed between the guide and the stand.

10. The rotational apparatus of claim 4, wherein a bearing is interposed between the guide and the stand.

11. The rotational apparatus of claim 5, wherein a bearing is interposed between the guide and the fixing member.

12. The rotational apparatus of claim 6, wherein a bearing is interposed between the guide and the fixing member.

13. The rotational apparatus of claim 7, wherein a bearing is interposed between the guide and the fixing member.

14. The rotational apparatus of claim 4, wherein the rotation hole has a latch groove around its outer surface, and
the electric clutch comprises a cylinder joined to the guide and having the shaft inserted therein and a latch member located in the cylinder and configured to latch onto the latch groove to press the inner surface at times of automatic rotation.

15. The rotational apparatus of claim 14, wherein the latch member has a shaft latch part configured to latch onto the latch groove and a cylinder latch part formed as a single body with the shaft latch part, and
the cylinder latch part has a cutting part configured to press the inner surface of the cylinder at times of automatic rotation.

16. The rotational apparatus of claim 15, wherein a power spring is joined to the shaft to provide a rotational force of an opposite rotary direction to that of the shaft.
